(19) United States
(12) Patent Application Publication
(10) Pub. No.: US 2024/0316657 A1
(43) Pub. Date: Sep. 26, 2024

(54) Combination tool

(71) Applicant: Exactaform Cutting Tools Limited, Coventry (GB)

(72) Inventor: Martyn Biddle, Coventry (GB)

(21) Appl. No.: 18/613,926

(22) Filed: Mar. 22, 2024

(30) Foreign Application Priority Data
Mar. 24, 2023 (GB) 2304344.1

(51) Int. Cl. B23B 51/10

(52) U.S. Cl. CPC B23B 51/10

(57) ABSTRACT

A combination tool for performing a cutting operation and a countersinking operation. The combination tool includes a cutting tool including a shank, a cutting portion comprising a forward end and at least one cutting edge, the cutting portion configured to perform the cutting operation in use, and at least one coolant channel extending between a rear end of the shank and the forward end of the cutting portion, such that a cooling fluid can flow through substantially a whole length of the cutting tool. The combination tool further includes a collar located around the cutting tool and fixed thereto, the collar comprising at least one countersink cutting edge and is configured, when the combination tool is in use, to perform the countersinking operation.

### CROSS-REFERENCE TO RELATED APPLICATIONS

The present application is based upon and claims the right of priority to GB Patent Application Number 2304344.1, filed Mar. 24, 2023, the disclosure of which is hereby incorporated by reference herein in its entirety for all purposes.

### TECHNICAL FIELD

The invention relates to a combination tool for performing cutting and countersinking operations.

### BACKGROUND

“Stack” materials may comprise layers of different material, such as carbon and aluminium, or carbon, titanium and aluminium, adhered together. Such stack materials may be used in aerospace and/or motorsport applications.

There exists a particular challenge in cutting stack materials (for example, drilling, boring or reaming) due to the heat generated by the cutting operation. When cutting carbon, a heat of approximately 400° C. may be generated and experienced by a cutting tool performing the cutting operation, and when cutting aluminium, a heat of approximately 300° C. may be generated and experienced by the cutting tool. Typically, the adhesive used to adhere the different materials of the stack together has a melting point much lower than the 300° C. or 400° C. generated during the cutting operation. For example, the adhesive may turn back to liquid at approximately 180° C. If the adhesive turns back to a liquid during the cutting operation, a paste is created that adheres to the cutting edges of the cutting tool, rendering the cutting action ineffective.

There exists a need for a tool that addresses the above-mentioned problems.

### SUMMARY

According to the invention in a first aspect, there is provided a combination tool for performing a cutting operation and a countersinking operation, the combination tool comprising: a cutting tool comprising: a shank, a cutting portion comprising a forward end and at least one cutting edge, the cutting portion configured to perform the cutting operation in use, and at least one coolant channel extending between a rear end of the shank and the forward end of the cutting portion, such that a cooling fluid can flow through substantially a whole length of the cutting tool via the at least one coolant channel; and a collar located around the cutting tool and fixed thereto, the collar comprising at least one countersink cutting edge and configured, when the combination tool is in use, to perform the countersinking operation.

Optionally, the cutting portion of the cutting tool defines a cutting diameter, and wherein the collar defines a countersinking diameter, wherein the countersinking diameter is greater than the cutting diameter.

Optionally, the collar is located rearward of the cutting portion of the cutting tool.

Optionally, the collar is located around the shank of the cutting tool and fixed thereto.

Optionally, the shank comprises an abutment surface, and wherein a rear end of the collar abuts the abutment surface.

Optionally, the collar comprises at least one cutting element fixed thereto, the at least one cutting element comprising the at least one countersink cutting edge.

Optionally, the collar comprises at least one flute comprising a cutting surface, and wherein the at least one cutting element is fixed to the cutting surface.

Optionally, the at least one countersink cutting edge is angled with respect to a longitudinal axis of the combination tool.

Optionally, the collar comprises a pair of cutting elements fixed to opposed sides of the collar, each cutting element comprises at least one countersink cutting edge.

Optionally, the collar is formed of a different material to the material forming the cutting tool.

Optionally, the cutting tool is formed from carbide.

Optionally, at least the cutting portion of the cutting tool is diamond coated.

Optionally, the collar is formed from steel.

Optionally, the at least one cutting element comprises a polycrystalline diamond, PCD, cutting element.

Optionally, the cutting portion of the cutting tool comprises at least one spiral flute defining the at least one cutting edge.

Optionally, the cutting tool comprises a pair of coolant channels.

According to the invention in a further aspect, there is provided a method of forming a combination tool, the method comprising: forming, from a drill rod blank, a cutting tool comprising: a shank, and a cutting portion comprising a forward end and at least one cutting edge, wherein the drill rod blank comprises at least one coolant channel extending therethrough, and wherein the at least one coolant channel extends between a rear end of the shank and a forward end of the cutting portion when the cutting tool is formed; locating a collar comprising at least one countersink cutting edge around the cutting tool; and fixing the collar to the cutting tool, wherein the cutting tool and the collar are configured, when the combination tool is in use, to perform a cutting operation and a countersinking operation respectively.

Optionally, the method further comprises diamond coating at least the cutting portion of the cutting tool.

Optionally, fixing the collar to the cutting tool comprises brazing the collar to a surface of the cutting tool.

Optionally, the method further comprises fixing the collar to the cutting tool after at least the cutting portion of the cutting tool is diamond coated.

### BRIEF DESCRIPTION OF THE DRAWINGS

FIG. 1 shows a perspective view of an exemplary combination tool;

FIG. 2 is a perspective view of a forward end of an exemplary combination tool;

FIG. 3 is a perspective view of a rear end of an exemplary combination tool;

FIG. 4 is a perspective view of an exemplary cutting tool; and

FIG. 5 is a perspective view of an exemplary collar.

### DETAILED DESCRIPTION

Generally disclosed herein is a combination tool for performing cutting and countersinking operations. The combination tool may be particularly suitable for cutting “stack” materials, the stack designating a plurality of materials adhered together, such as carbon and aluminium, or carbon, titanium and aluminium. As outlined above, when cutting “stack” materials, it is critical that the temperature of the cutting tool does not increase above the melting point of the adhesive that binds the different materials of the stack together.

Coolant holes/channels, which run through the length of the tool and through which a cooling fluid can be passed, may be used to prevent excessive temperature increases of the tool during a cutting operation. Typically, a drill rod blank may be provided comprising coolant holes, and a cutting tool may be formed by machining the drill rod blank to form the desired cutting edges and, optionally, shank profile.

The inventors have realised that there exists a particular challenge in providing a combination tool with coolant holes/channels and which can perform both a cutting operation (such as drilling, boring or reaming) and a countersinking operation. This is because, machining the drill rod blank to form the conical or tapered countersinking portion would reduce the diameter of the portion of drill rod blank located forwardly of the tapered countersinking portion. As such, the coolant holes/channels running through the portion of the drill rod blank located forwardly of the tapered countersinking portion would be interrupted and no longer continuously run through the tool. Crucially, the coolant holes/channels would be interrupted in the forward portion of the drill rod blank, which would be formed into a cutting portion of the cutting tool (i.e. the portion intended to undertake the cutting operation before the countersinking operation). As such, cooling the cutting portion of the cutting tool during the cutting operation would not be possible.

Generally disclosed herein, is a combination tool for performing a cutting operation and a countersinking operation. The combination tool comprises a cutting tool, which may be formed from a drill rod blank, and which comprises a shank, a cutting portion, and at least one coolant channel extending from a rear end of the shank to a forward end of the cutting portion. The cutting portion comprises at least one cutting edge and is configured to perform the cutting operation. The combination tool further comprises a collar located around the cutting tool and fixed thereto. The collar comprises at least one countersink cutting edge configured to perform the countersinking operation.

The inventors have realised that by locating a collar, configured to perform a countersinking operation, around the cutting tool and fixing it thereto, the coolant holes/channels that run the length of the cutting tool are preserved while still providing a tool with a combination cutting and countersinking function.

The term “collar” may encompass any sleeve, cartridge or other component capable of locating around the cutting tool and/or receiving the cutting tool.

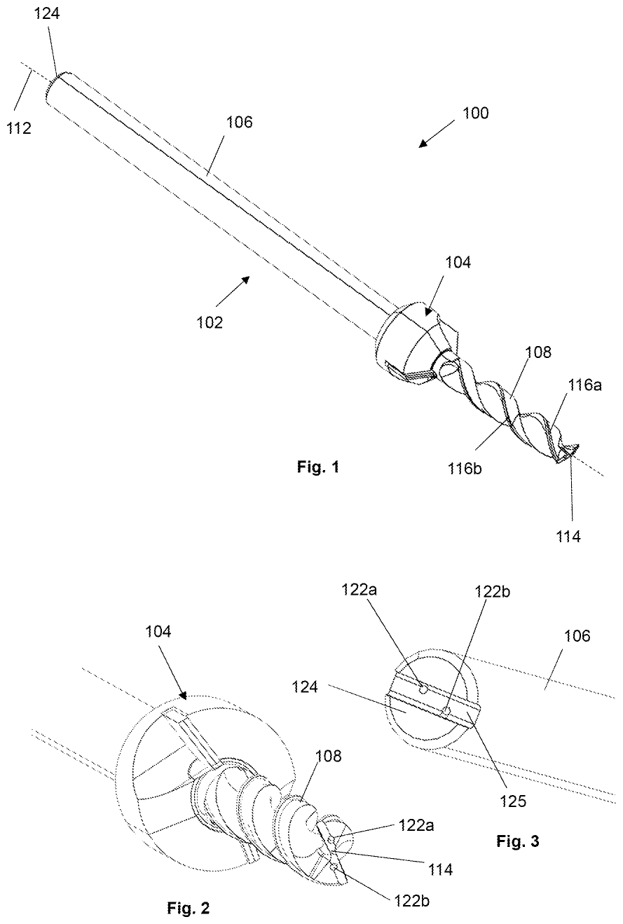

FIG. 1 shows a perspective view of an exemplary combination tool 100. The combination tool 100 is so-called because it may be used to perform more than one machining operation, and may do so in a single pass. In this case, the combination tool 100 is configured to perform a cutting operation (for example, drilling, boring or reaming a hole) and a countersinking operation. The combination tool 100 may be a rotary combination tool, and as such, configured to perform a rotary cutting operation and countersinking operation.

The combination tool 100 comprises a cutting tool 102 and a collar 104.

The cutting tool 102 is substantially cylindrical. In the exemplary arrangement shown in FIG. 1, the cutting tool 102 is formed from a generally cylindrical drill rod blank. The cutting tool 102 comprises a shank 106 and a cutting portion 108. In the exemplary arrangement shown in FIG. 1, in which the cutting tool 102 is formed from a generally cylindrical drill rod blank, the drill rod blank is machined at a forward end thereof to form the cutting portion 108.

The shank 106 is configured for engagement in a drive tool, such as a drill, for providing rotary motion about a longitudinal axis 112 of the cutting tool 102. As can be seen from FIG. 1, since the collar 104 is concentrically located around the cutting tool 102, the longitudinal axis 112 is also the longitudinal axis of the collar 104, and the combination tool 100. In the exemplary arrangement shown in FIG. 1, the shank 106 has a substantially cylindrical cross-section. The skilled person will appreciate that alternative cross-sections may be used. For example, substantially all of the shank 106, or a portion of the shank 106, may be prismatic in shape, to correspond to the profile of the receiving portion of the drive tool.

The cutting portion 108 of the cutting tool 102 is configured to perform a cutting operation. The cutting portion 108 defines a cutting diameter, which defines the dimensions of the hole drilled, reamed or bored when the combination tool 100 is in use.

The cutting portion 108 comprises cutting edges. In the arrangement shown in FIG. 1, the cutting portion 108 comprises a tip 114 at a forward end thereof (that is, the end of the combination tool 100 that would contact a workpiece first in a cutting operation). The cutting portion 108 further comprises a pair of flutes 116a, 116b. The cutting edges are provided by the tip 114 and/or the pair of flutes 116a, 116b. The pair of flutes 116a, 116b extend along substantially the whole length of the cutting portion 108. The pair of flutes 116a, 116b comprise spiral/helical flutes. The skilled person will appreciate that the number and type of cutting edges of the cutting portion 108 shown in FIG. 1 are exemplary only, and that different combination tools may comprise a different number of cutting edges and/or a different type of cutting edges according to the specific cutting operation required. As such, in alternative arrangements, the profile of the cutting portion 108 may be different.

The cutting tool 102 comprises a pair of coolant holes/channels 122a, 122b. The skilled person will appreciate that in alternative arrangements, a different number of coolant channels may be provided (for example, a single coolant channel, or three or more coolant channels). The coolant channels 122a, 122b extend continuously through and along substantially the whole length of the cutting tool 102 from a rear end 124 of the shank 106 to the forward end of the cutting portion 108. This can be seen in FIG. 2, which shows outlets of the respective coolant channels 122a, 122b at a forward end of the cutting tool, and specifically a forward end of the cutting portion 108 of the cutting tool 102. FIG. 3 shows inlets of the respective coolant channels 122a, 122b at the rear end 124 of the shank 106. The cooling fluid may enter the inlets of the respective coolant channels 122a, 122b at the rear end 124 of the shank 106 of the cutting tool 102, travel through the length of the cutting tool 102 and exit the cutting tool 102 at the outlets of the respective coolant channels 122a, 122b at the forward end of the cutting portion 108. As can be seen in FIG. 3, the cutting tool 102 may also comprise a trough 125. The trough 125 extends across a rear face of the shank 106. The trough 125 is configured to direct cooling fluid into the inlets of the coolant channels 122a, 122b. In the arrangement shown in FIG. 3, the inlets of the coolant channels 122a, 122b are located at least partially within the trough 125.

In the exemplary combination tool 100, the coolant channels 122a, 122b comprise helical coolant channels. In alternative arrangements, the coolant channels may comprise straight coolant channels that extend through the length of the cutting tool parallel to the longitudinal axis 112 of the combination tool 100.

The inlets and outlets of the coolant channels 122a, 122b are offset from the longitudinal axis of the cutting tool 102. The coolant channels 122a, 122b extend through the cutting tool 102 such that they are substantially symmetrical to one another about the longitudinal axis. The cutting portion 108 of the cutting tool 102 is dimensioned and profiled such that the coolant channels 122a, 122b are uninterrupted and run continuously through the cutting portion 108 of the cutting tool 102. In other words, the minimum outer radial dimension of the cutting portion 108 is greater than the maximum radial extent of the cutting channels 122a, 122b.

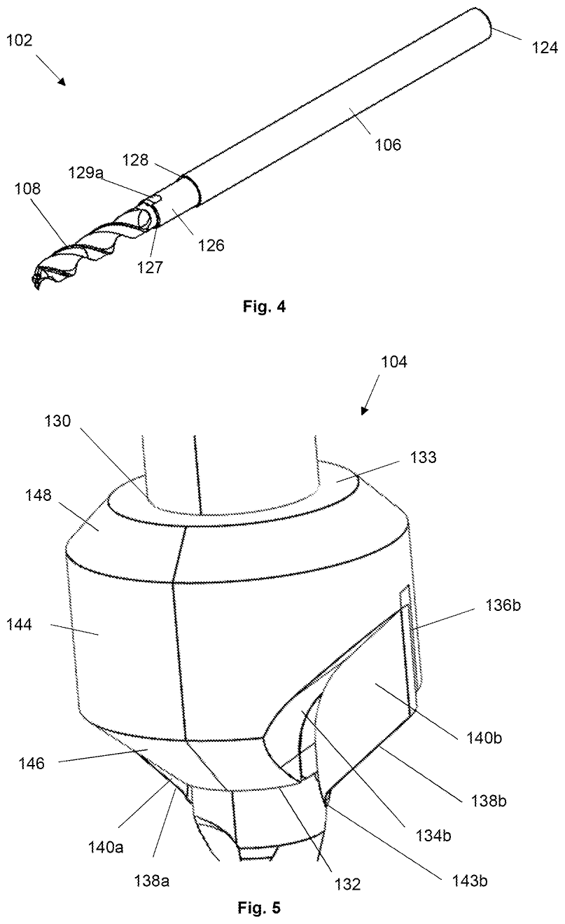

The shank 106 may comprise a collar receiving portion 126, as is visible in FIG. 4 which shows the cutting tool 102 in isolation from the collar 104. The collar receiving portion 126 may be of reduced outer dimension when compared to the outer dimension of the rest of the shank 106, such that a circumferentially extending abutment surface 128 is provided. At least a portion of the collar 104 abuts the abutment surface 128 when the collar 104 is fixed to the cutting tool 102. The collar receiving portion 126 may be of larger outer dimension that the same outer dimension of the cutting portion 108 such that a circumferentially extending shoulder is formed 127.

The collar receiving portion 126 may comprise a fluted region. In the exemplary cutting tool 102 shown in FIG. 4, the collar receiving portion 126 comprises a pair of opposed fluted regions 129a, 129b (only one of which is visible in FIG. 4). The fluted regions 129a, 129b may align with at least a portion of a respective flute of the collar 104 to form a continuous flute extending along the collar receiving portion 126 and the collar 104. The flutes of the collar 104 will be discussed in more detail below.

The cutting tool 102 may be formed from any suitable material. In one exemplary arrangement, the cutting tool 102 is formed from carbide, which may be tungsten carbide. The cutting tool 102 may be diamond coated. In exemplary arrangements, substantially the whole of the cutting tool 102 is diamond coated, while in other arrangements, only the cutting portion of the cutting tool 102 is diamond coated.

The collar 104 locates around the cutting tool 102 and is fixed thereto. In the exemplary arrangement of FIG. 1, the collar 104 is concentrically located around the cutting tool 104. The collar 104 is rotationally and axially fixed relative to the cutting tool 102.

In the exemplary arrangements shown in the drawings, the collar 104 extends completely circumferentially around the cutting tool 102 when fixed thereto. The length of the collar 104 is less than the length of the cutting tool 102 such that a portion of the cutting tool 102 extends forwardly and rearwardly from the collar 104 when the collar 104 is fixed thereto.

The collar 104, shown in close-up in FIG. 5, defines an aperture 130 which extends therethrough and which receives the cutting tool 102 therein. In the exemplary combination tool 100 shown in FIG. 1, the collar 104 is configured to receive and locate around the shank 106 of the cutting tool 102. As such, the aperture 130 is dimensioned and profiled to correspond to an outer dimension of the shank 106. Specifically, the aperture 130 is dimensioned and profiled to correspond to the outer dimension of the collar receiving portion 126 of the shank 106.

The collar 104 is fixed to the shank 106 such that a forward end 132 of the collar 104 is located at substantially a rearward end of the cutting portion 108 of the cutting tool 102. A small portion of the forward end of the shank 106 may extend from the forward end 132 of the collar 104. The skilled person will appreciate that the collar 104 is fixed to the shank 106 in a position such that the workpiece being cut encounters the collar 104 to perform the countersinking operation significantly immediately after the entire length of the cutting portion 108 of the cutting tool 102 has engaged the workpiece. A rear end 133 of the collar 104 may abut the circumferentially extending abutment surface 128 of the shank 106. This allows the collar 104 to be correctly located on the shank 106 as well as providing an additional fixing surface, as will be explained in more detail below.

The collar 104 comprises a pair of flutes 134a, 134b. Only 134b is visible in FIG. 5, however the flute 134a is similar to flute 134b but opposed. The flutes 134a, 134b are equally angularly spaced about the longitudinal axis of the collar 104. In the arrangement shown in FIG. 5, in which the collar 104 comprises two flutes, the flutes 134a, 134b are therefore angularly separated by substantially 180 degrees about the longitudinal axis of the collar 104. In alternative arrangements, a different number of flutes may be provided. The flutes in alternative arrangements may be equally angularly separated or unequally angularly separated. The pair of flutes 134a, 134b may align with the fluted regions 129a, 129b when the collar is located on and fixed to the collar receiving region 126 of the cutting tool 102.

Each flute 134a, 134b comprises a cutting surface 136a, 136b. Each of the cutting surfaces 136a, 136b comprise a countersink cutting edge 138a, 138b. In the arrangement shown in FIG. 5, the countersink cutting edges 138a, 138b are formed by a cutting element 140a, 140b. The cutting elements 140a, 140b are fixed to the respective cutting surfaces 136a, 136b. In alternative arrangements, the countersink cutting edges 138a, 138b may be formed by the respective flutes 134a, 134b.

The cutting elements 140a, 140b are substantially planar. The cutting surfaces 136a, 136b to which the cutting elements 140a, 140b are fixed extend parallel to the longitudinal axis of the collar 104.

The countersink cutting edges 138a, 138b are angled with respect to the longitudinal axis of the collar 104. That is, when the cutting elements 140a, 140b are fixed to the collar 104, the countersink cutting edges 138a, 138b are angled with respect to the longitudinal axis. The angle at which the countersink cutting edges are disposed with respect to the longitudinal axis defines the countersink angle, and the skilled person will appreciate that this angle may vary depending on the countersink required. The collar 104 defines a countersinking diameter, which is greater than the cutting diameter defined by the cutting portion 108 of the cutting tool 102. Each of the cutting elements 140a, 140b may define tips 143a, 143b. The tips 143a, 143b may facilitate the formation of the countersink, and specifically the transition from diameter to the chamfer.

The collar 104 comprises a first portion 144 which is substantially cylindrical. In the exemplary collar 104 shown in FIG. 5, the collar 104 further comprises a forward tapered portion 146 and a rear tapered portion 148 extending from forward and rear ends of the first portion 144 respectively, although the skilled person will appreciate that in alternative arrangements only one tapered portion may be provided (e.g. only the forward tapered portion), or indeed no tapered portion may be provided. The flutes 134a, 134b extend rearwardly from the forward end of the collar 132, along the forward tapered portion 146 and partially along the first portion 144.

The angle formed by the countersink cutting edges 138a, 138b with respect to the longitudinal axis substantially corresponds to the angle the forward tapered portion 146 of the collar 104 forms with respect to the longitudinal axis. The cutting elements 140a, 140b are fixed to the respective cutting surfaces 136a, 136b such that at least a portion of each of the cutting elements 140a, 140b, and specifically the countersink cutting edges 138a, 138b, overhang the forward tapered portion 146 of the collar 104 in the direction of the longitudinal axis. As such, in use, the countersink cutting edges 138a, 138b contact the workpiece during use of the combination tool 100 to perform a countersinking operation, and the forward tapered portion 146 of the collar 104 does not contact the workpiece. The cutting elements 140a, 140b sit substantially flush with an outer surface of the first portion 144 in the radial direction.

The collar 104 may be formed from a different material to that of the cutting tool 102. For example, the collar 104 may be formed of one of steel, tungsten carbide and a tungsten heavy alloys. The cutting elements 140a, 140b may be formed of one of polycrystalline diamond (PCD), carbide, Cermet (a composite material comprising ceramic and metallic materials) and monocrystalline diamond.

In use, the combination tool 100 is engaged with a drive tool, such as a drill. The drive tool provides rotary motion about the longitudinal axis of the combination tool 100. The drive tool is also suitable for expelling a cooling fluid into the coolant channels 122a, 122b.

The drive tool is actuated, which causes the combination tool 100 to rotate about its longitudinal axis 112. The combination tool 100, and specifically the cutting portion 108 of the cutting tool 102, is then brought into contact with a workpiece to perform a cutting operation thereupon. In this example, the workpiece comprises a stack material, for example, comprising aluminium and carbon, however the skilled person will appreciate that the combination tool 100 may be used with other materials/workpieces. An operator may wish to drill, bore or ream a hole in the stack material. The tip 114 of the cutting tool 102 is brought into contact with the stack material and together with the cutting edges of the flutes 116a, 116b, the cutting operation is undertaken and a hole is drilled, reamed or bored in the stack material.

Throughout the cutting operation, cooling fluid is pushed through the coolant channels 122a, 122b. Since the coolant channels 122a, 122b extend from the rear end 124 of the shank 106 to the forward end of the cutting portion 108, the cooling fluid travels the through the whole length of the cutting portion 108 of the combination tool 100 and acts to cool the cutting portion 108 during the cutting operation. As such, the temperature of the cutting portion 108 remains under the melting point of the adhesive of the stack material, and the integrity of the stack material and the cutting operation is maintained (that is, the adhesive does not melt and turn to liquid and compromise the cutting edges of the cutting portion 108).

On completion of the cutting operation, substantially all of the cutting portion 108 may have passed through the stack material. Continued use of the combination tool brings the countersinking cutting edges 138a, 138b into contact with the stack material and the countersinking operation begins to create a countersink in the stack material. On completion of the countersinking operation, the combination tool 100 is withdrawn from the workpiece.

A method of manufacturing the combination tool 100 will now be described with reference to FIGS. 1-5.

The cutting tool 102 is formed from a drill rod blank. The drill rod blank comprises coolant channels 122a, 122b running therethrough. The drill rod blank may be a carbide, or tungsten carbide, drill rod blank.

The drill rod blank may be machined to form the collar receiving portion 126 and the abutment surface 128. The drill rod blank is further machined to form the cutting portion 108 comprising the tip 114 and the cutting edges, which in this example, are formed by flutes 116a, 116b.

Once the cutting tool 102 has been formed, it may be diamond coated. The cutting tool 102 may be diamond coated using chemical vapour deposition (CVD) for example. Diamond-coating the cutting tool 102 offers improved tool life.

The collar 104 may then be located on the cutting tool 102, specifically the collar 104 may be located around the shank receiving portion 126 of the cutting tool 102. The rear end 133 of the collar 104 is brought into abutment with the abutment surface 128 of the cutting tool 102. The collar 104 may then be brazed onto the cutting tool 102. Specifically a portion of the rear end 133 of the collar 104 is brazed onto the abutment surface 128 of the shank, and an inner surface of the collar 104 formed by the aperture 130 is brazed onto the outer surface of the shank receiving portion 126. The skilled person will appreciate that in alternative methods, alternative ways of fixing the collar 102 to the cutting tool 102 may be used.

Advantageously, the collar 104 is brazed onto the cutting tool 102 after the cutting tool 102 is diamond coated. This prevents the coating process from “wetting” the braze, or debrazing the joint, rendering the tool unusable. In alternative arrangements, the collar 104 may be brazed onto the cutting tool 102 before the cutting tool 102 is diamond coated, and in this case, the brazing may occur under a vacuum to prevent debrazing.

It will be appreciated by the person of skill in the art that various modifications may be made to the above described embodiments without departing from the scope of the invention.

1. A combination tool for performing a cutting operation and a countersinking operation, the combination tool comprising:
a cutting tool comprising:
a shank,
a cutting portion comprising a forward end and at least one cutting edge, the cutting portion configured to perform the cutting operation in use, and
at least one coolant channel extending between a rear end of the shank and the forward end of the cutting portion, such that a cooling fluid can flow through substantially a whole length of the cutting tool via the at least one coolant channel; and
a collar located around the cutting tool and fixed thereto, the collar comprising at least one countersink cutting edge and configured, when the combination tool is in use, to perform the countersinking operation.

2. A combination tool according to claim 1, wherein the cutting portion of the cutting tool defines a cutting diameter, and wherein the collar defines a countersinking diameter, wherein the countersinking diameter is greater than the cutting diameter.

3. A combination tool according to claim 1, wherein the collar is located rearward of the cutting portion of the cutting tool.

4. A combination tool according to claim 1, wherein the collar is located around the shank of the cutting tool and fixed thereto.

5. A combination tool according to claim 1, wherein the shank comprises an abutment surface, and wherein a rear end of the collar abuts the abutment surface.

6. A combination tool according to claim 1, wherein the collar comprises at least one cutting element fixed thereto, the at least one cutting element comprising the at least one countersink cutting edge.

7. A combination tool according to claim 6, wherein the collar comprises at least one flute comprising a cutting surface, and wherein the at least one cutting element is fixed to the cutting surface.

8. A combination tool according to claim 1, wherein the at least one countersink cutting edge is angled with respect to a longitudinal axis of the combination tool.

9. A combination tool according to claim 6, wherein the collar comprises a pair of cutting elements fixed to opposed sides of the collar, each cutting element comprises at least one countersink cutting edge.

10. A combination tool according to claim 1, wherein the collar is formed of a different material to the material forming the cutting tool.

11. A combination tool according to claim 1, wherein the cutting tool is formed from carbide.

12. A combination tool according to claim 1, wherein at least the cutting portion of the cutting tool is diamond coated.

13. A combination tool according to claim 1, wherein the collar is formed from steel.

14. A combination tool according to claim 6, wherein the at least one cutting element comprises a polycrystalline diamond, PCD, cutting element.

15. A combination tool according to claim 1, wherein the cutting portion of the cutting tool comprises at least one spiral flute defining the at least one cutting edge.

16. A combination tool according to claim 1, comprising a pair of coolant channels.

17. A method of forming a combination tool, the method comprising:
forming, from a drill rod blank, a cutting tool comprising:
a shank, and
a cutting portion comprising a forward end and at least one cutting edge,
wherein the drill rod blank comprises at least one coolant channel extending therethrough, and wherein the at least one coolant channel extends between a rear end of the shank and a forward end of the cutting portion when the cutting tool is formed;
locating a collar comprising at least one countersink cutting edge around the cutting tool; and
fixing the collar to the cutting tool,
wherein the cutting tool and the collar are configured, when the combination tool is in use, to perform a cutting operation and a countersinking operation respectively.

18. A method according to claim 17, further comprising diamond coating at least the cutting portion of the cutting tool.

19. A method according to claim 17, wherein fixing the collar to the cutting tool comprises brazing the collar to a surface of the cutting tool.

20. A method according to claim 18, comprising fixing the collar to the cutting tool after at least the cutting portion of the cutting tool is diamond coated.
